(19) United States
(12) Patent Application Publication
(10) Pub. No.: US 2004/0114462 A1
(43) Pub. Date: Jun. 17, 2004

(54) Process and devices for homogeneously mixing a solid phase which is present in finely dispersed state with a fluid

(76) Inventors: Stephan Andreas Schunk, Heidelberg (DE); Andreas Strasser, Blumenstrasse 1 69239 Neckarsteinach (DE)

Correspondence Address: Stephen D Scanlon, Jones Day, North Point, 901 Lakeside Avenue, Cleveland, OH, 44114, US

(21) Appl. No.: 10/469,493

(22) PCT Filed: Mar. 8, 2002
(86) PCT No.: PCT/EP02/02586

(30) Foreign Application Priority Data
Mar. 8, 2001 (DE) 101 11 231.9

(51) Int. Cl. B01F 13/08; B01J 19/00

(52) U.S. Cl. 366/348; 366/279

(57) ABSTRACT

The present invention provides a process for the homogeneous mixing of a finely dispersed solid phase with a fluid in a vessel (12), whereby a means (11) for mixing the solid phase (13) is moveably arranged in the vessel (12) and whereby the diameter of the means (11) is 70-99% of the inner diameter of the vessel (12). Further, the present invention comprises an array, which comprises a plurality of devices according to the invention for the parallel homogeneous mixing of a plurality of solid phases with the same or different fluids.

The present invention relates to a process and to a device for the homogeneous mixing of a finely dispersed solid phase with a fluid according to the respective preamble of the independent claims 1 and 7, as well as an array comprising a plurality of devices according to the invention.

Processes for coating, respectively for soaking, of solid phases, of powders and granulates of solid materials, particularly by applying mechanical agitation make generally use of two different techniques. On the one hand, powders, granulates or shaped bodies are continuously soaked with liquids by using a so-called “rotating addition” device. This is described, for example, by C. Perego et al. “Catalysis today” 34 (1997), pages 281 to 305 and in “Preparation of solid catalysts”, editors G. Ertl, H. Knüzinger, J. Weitkamp, page 579, Verlag Chemie, Weilheim, 1999.

According to the state of the art, a rotating disk or a rotating cylinder with a defined wall height is arranged to the horizontal line at a defined angle. A powder or a granulate is placed in said rotating cylinder or onto said rotating disk and the rotation of the cylinder or the disk, provides a thorough mixing of the powder or granulate with the solution or the liquid to be introduced.

The retention time of the shaped bodies on the disk, and therefore the degree of soaking, can be adjusted by the height of the border of the disk and by the angle of inclination of the disk or the cylinder, respectively. In this arrangement for the soaking procedure, a defined size of the shaped body is required for a successful soaking, since below a defined size, the gravitational forces acting on the shaped body are too small compared to the adhesion of the shaped body to the disk or to the cylinder, which is due of the capillary forces in the presence of the liquid that is distributed on the disk, to allow the rotation of the shaped bodies on the disc or cylinder below a defined size of about less than 5 mm. In other words, the aforementioned process cannot be scaled down arbitrarily. A further disadvantage of this process is the fact that soaking will only occur up to a defined degree of absorption of liquid by the shaped body, whereby subsequently a “pasting” of the shaped bodies and a sharp increase of the viscosity typically occurs, so that the mixing of the material to be soaked, i.e. of the shaped bodies, is no longer satisfying. Typically, the process is continued by using a so-called pan grinder in these cases.

The so-called pan grinding is the second aforementioned possibility. The pan grinding is carried out in typical pan grinders, whereby powders are kneaded by rollers and by the introducing of mechanical energy a good thorough mixing of the powders with the fluid is assured also at high degrees of moisture. Disadvantages of the known pan grinding methods are also the lack of a possibility for the miniaturization, since pan grinders must have a defined size.

Further, pan grinding methods do not allow the use of granulates or larger shaped bodies instead of finely dispersed powders since they would be destroyed by the mechanical attrition due to the rollers.

These methods are widely used in the field of chemistry and materials science. For example, this also applies to the production of heterogeneous catalysts by combinatorial methods. These heterogeneous catalysts especially comprise the so-called supported-catalysts that are widely used since they combine a relatively high content of an active component on a surface of an body with a high degree of thermostability of the catalytic component.

Considering the aforementioned disadvantages inherent to the methods of the state of the art, the object of the present invention was to develop a process and a device for the homogeneous mixing of a finely dispersed solid phase, with a fluid, which avoids the disadvantages of the state of the art as described above and which satisfies the following requirements:

1. Good mechanical mixing, both at a high and a low moisture content of the powder or the granulate.

2. Soaking of the shaped bodies or granulates by avoiding their mechanical destruction.

3. Possibility of miniaturization of the process.

This object is met by the present invention and by the process according to the invention by using a means for mixing the solid phase in a vessel, whereby the means is arranged freely moveable and whereby the diameter of this means is 70-99% of the inner diameter of the vessel. Thereby, a permanent mechanical mixing of the solid phase is assured, whereby the solid phase may essentially consist of, for example, a powder, granulates or other shaped bodies.

Thereby, said granulates or shaped bodies which essentially are forming the solid phase may be mixed, i.e. soaked, homogeneously with the fluid without their mechanical destruction.

It is preferred, that the primary structure of the solid phase remains unchanged, as to also allow the mixing of highly fragile granulates or shaped bodies with a fluid in the process according to the invention.

It is particularly preferred, that the solid phase has a porous primary structure in order to allow the absorption of a defined amount of a fluid, which is preferably a liquid, by a pre-defined adjustment of the porosity.

Thereby, the fluid is preferably brought homogeneously into the solid phase, so that a uniform mixing of the solid phase by the process according to the invention is possible.

In a further preferred embodiment, the process is carried out in a parallel manner to allow the homogenous mixing of a plurality of different solid phases with a fluid simultaneously.

Furthermore, the object of the present invention is solved by a device for carrying out the process according to the invention, whereby the device comprises a means for mixing the solid phase, which is arranged so that it moves freely and whereby the diameter of the means for mixing the solid phase amounts to up to 70-99% of the inner diameter of the vessel. Due to the ratio of the diameter of the means to the inner diameter of the vessel as defined according to the invention, the device is adjusted to the process in such a way that mechanical mixing of the solid phase occurs during the homogeneous mixing with a fluid.

Preferably, the means for mixing of the solid phase is magnetic or magnetizable and further means for applying a magnetic field are provided, whereby the magnetic field can be altered locally in a continuous or periodical way.

Thus, the ability of the means for moving freely and easily during mixing is provided in the vessel, whereby by appropriate means, the speed of the means for mixing, which is, for example, rotating in the vessel, can be adjusted. The continuous or periodical change of the magnetic field further provides an enhanced homogeneous mixing of the solid phase. In a particularly preferred embodiment, the means for mixing the solid phase has paddle-like regions, thus enabling a particularly intense and homogeneous mixing of the solid phase with a fluid.

The object of the present invention is further solved by an array comprising a plurality of devices according to the invention, thus enabling the simultaneous and homogeneous mixing of any plurality of different solid phases or shaped bodies, with different fluids or with the same fluid.

The terms used in the context of the present invention shall be explained as follows:

Solid Phase:

This term essentially describes a plurality of shaped bodies, which is not defined in numerical terms and exists in the solid state under normal conditions.

Fluid:

A medium is defined as a fluid or a fluid medium, if its flowability is proportional to the expression γE/RT, whereby γE is the energy which has to be overcome for the flowing of the medium. This includes e.g. liquids, gases, waxes, dispersions, emulsions, sols, gels, fats, suspensions, melts, powdery solids, and so on.

Shaped Bodies:

This term comprises essentially all three-dimensional units and bodies with a rigid or a semi-rigid surface, which can be either flat or can have openings, pores or bores or channels. The shaped body has-to be suitable to absorb substances or a fluid medium. There are no restrictions with regard to the outer form of the shaped body as long as a three-dimensional unit or a three-dimensional body is provided. Thus, the shaped body can have the form of a sphere or a hollow sphere, or of an ellipsoid body, a cuboid, a cube, a cylinder, a prism, or a fractal body.

Material:

The term “material” preferably comprises non-gaseous substances, as for example solids, sols, gels, wax-like substances, or substance mixtures, dispersions, emulsions or suspensions.

Therefore, molecular or non-molecular chemical compounds, formulations, mixtures are concerned, whereby the term “non-molecular” defines substances which can be continuously optimized or altered in contrast to “molecular” substances, whose structural features can only be altered by a variation of discrete states, for example by the variation of a substitution pattern.

Monomodal:

In the present application, “monomodal” is defined in such a way that the shaped bodies consist only of one essentially homogeneous geometric form, whereby their particle size distribution (PSD) amounts to ±30% of the median of the overall particle size distribution.

The term “polymodal” is in contrast to this definition, since the shaped bodies may consist of an arbitrary plurality of geometric forms, and thus, the shaped bodies are essentially non-homogeneous.

Porosity:

Bodies have a porosity, i.e. they are porous if they have micropores, mesopores, and/or macropores according to the IUPAC definition or if they display a combination of two or more of those, with a pore distribution which may be mono-, bi-, or multi-modal. In the context of the present invention, the particles preferably have a multimodal pore distribution with a high content, i.e. more than 50%, of macropores. Examples comprise ceramic foams, metallic foams, metallic or ceramic monoliths, hydro gels, polymers, in particular PU foams, composites, sintered glasses, or sintered ceramics. The porosity of such a shaped body has in general a BET surface of 1 to 1000, preferably 2 to 800, and more preferably 3 to 100 m²/g.

Primary Structure:

The term “primary structure” shall describe the state of the components of the solid phase before they are exposed to a mixing process. Such states may be for example: a specific porosity, no porosity, a defined quality of the surface, a defined morphology, in particular size, form, and shape of the bodies.

Further advantages and embodiments of the invention are provided by the description, the example and the enclosed Figures.

It is understood that the above mentioned and the following features which still have to be explained cannot only be used in the respective given combination but also in any other combination or as a single feature without leaving the scope of the present invention.

The invention is explained by an example and schematically represented in the Figures and is described in detail in the following by making reference to the Figures.

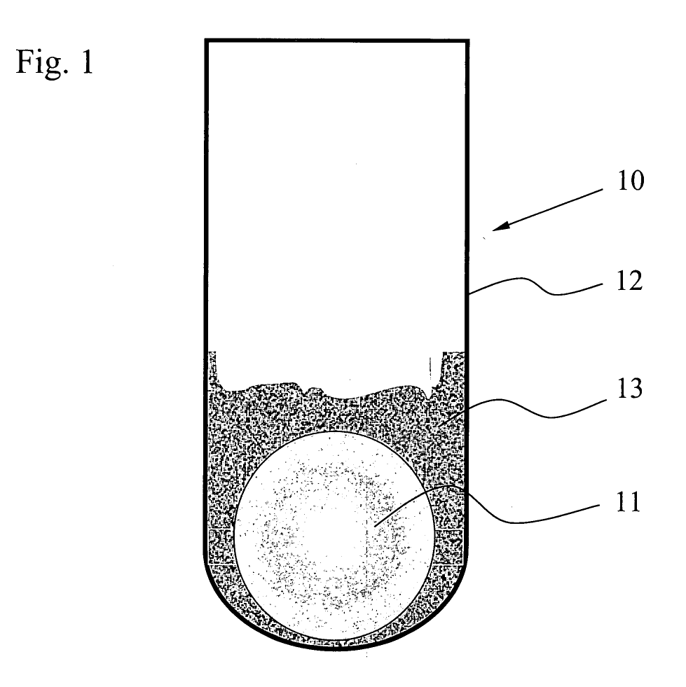

FIG. 1 schematically shows the device according to the invention according to claim 7.

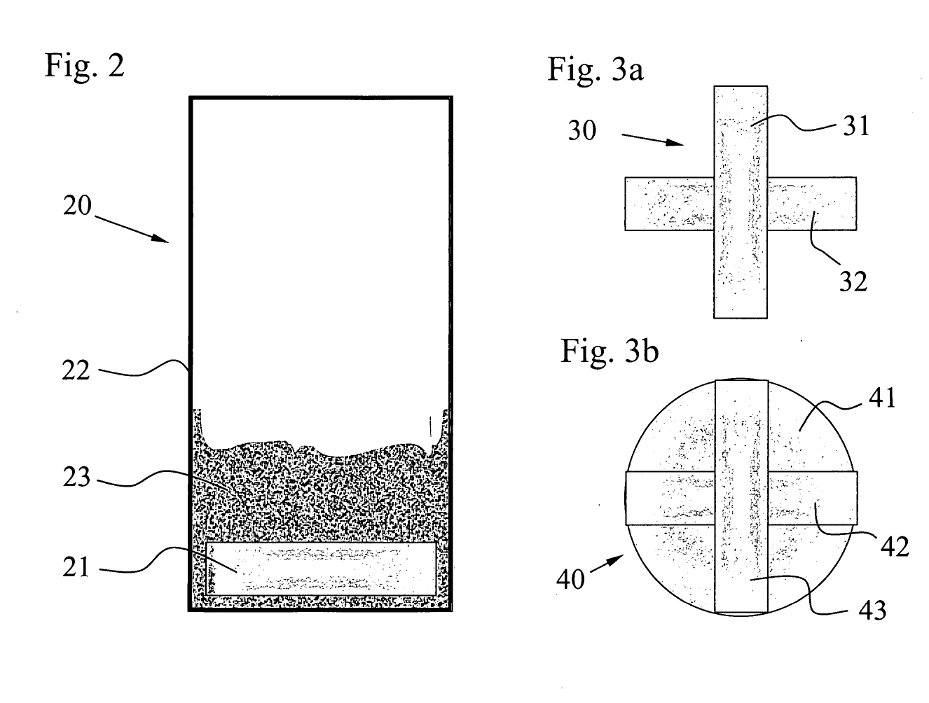

FIG. 2 schematically shows a further embodiment of the device of the invention according to claim 7.

In FIG. 3a and FIG. 3b, two different embodiments of the means for mixing a solid phase with a fluid are shown.

FIG. 1 schematically shows an embodiment of the device according to the invention according to claim 7. Here, the device (10) comprises a vessel (12) with a rounded bottom. The vessel (12) is charged with a solid phase, for example a finely dispersed powder (13), up to a previously defined height H. In the solid phase (13) the means (11) for mixing the solid phase is provided. In the present case, the means (11) is designed in the form of a discus shaped body which is standing on its border line. The diameter d of the discus shaped means (11) thereby amounts to 75% of the inner diameter D of the vessel (12). In this embodiment according to FIG. 1, a vessel (12) with a rounded bottom is particularly preferred due to the shape of the means (11) since the amount of the solid phase which is below the means (11) can be mixed particularly homogeneously.

The size and weight of the means (11) are obviously adjusted according to the respective composition, or to the physical properties, of the solid phase (12).

Thus, the appropriate scaling of the means (11) for mixing allows for the use of a plurality of solid phases, for example of powders of different density and constitution, which have to be mixed homogeneously with a fluid. Further, the specific scaling of the means (11) allows for selecting from a multitude of different fluids.

FIG. 2 shows a further schematic view of an embodiment of the device according to the invention.

The device (20) comprises a vessel (22) which is charged up to a height H with a solid phase, for example a finely dispersed granulate or a finely dispersed powder. In this case, the vessel (22) has a plane bottom. The solid phase (23) contains a means (21) for mixing the solid phase. The ratio of the diameter d of the means (21) for mixing the solid phase (23) amounts to 75% of the inner diameter D of the vessel (22).

As explained above in the context of FIG. 1, the suitable scaling of diameter d and of diameter D allows to take suitable measures with respect to different material requirements concerning the solid phase and the fluid.

With respect to FIGS. 1 and 2, arrangements that are not shown are provided, as for example magnetic stirrer or the like which allows for a periodical or continuous rotation of the means (11) or (21), for mixing the solid phases (13) or (23). In FIG. 1 and FIG. 2, the means (11) or (21) consist of a teflon-coated magnetizable iron core.

In FIG. 3a, an embodiment of the means (11) for mixing the solid phase [here marked as means (30)] is shown. Here, the means (30) comprises successively cross-wise arranged beam-like teflon-coated iron cores. Thereby a beam-like teflon-coated part (31) is in strong and direct contact with the other beam-like part (32). The dimension of the means (30) also depends on the scaling of the corresponding vessel, wherein the component (30) is used afterwards for mixing with a solid phase.

FIG. 3b shows a further embodiment of the means (11) [here marked as means (40)] for mixing a solid phase. In this case the means (40) consists of a discus shaped body, which for example may be rotating upright, as for example shown in FIG. 1. On the discus shaped body (41), two paddle-like components (42) and (43) are arranged in a firm connection and analogously to FIG. 3a. Due to the paddle-like components (42) and (43), a particularly good mixing of the solid phase in a corresponding vessel, preferably with a rounded bottom is provided. The paddle-like components (42) and (43) may be arranged only on one side of the discus shaped form body (41), or also on both sides of the discus shaped body (41). The arrangement may be varied depending upon the kind of solid phase used.

As far as the solid phase is concerned, the process according to the invention, allows for the easy use of heterogeneous or heterogeneously made catalysts, luminophores, thermoelectric, piezoelectric, semi-conducting, electro-optical, supraconductive or magnetic substances or mixtures of two or more of these substances, in particular inter-metallic compounds, oxides, mixtures of oxides, mixed oxide systems, ionic or covalent compounds of metals and/or non-metals, metal alloys, ceramics, organ-metallic compounds and composite materials, dielectric materials, thermoelectric materials, magneto-resistive and magneto-optical materials, organic compounds, enzymes and enzyme mixtures, pharmaceutically active substances, substances for fodder and fodder supplementing substances, substances for food and food supplementing substances, and cosmetics and mixtures of two or more of the aforementioned substances.

The inside of the discus-shaped body (41) comprises an iron core or other permanently magnetic or permanently magnetizable alloys or metals, such as a cobalt containing alloy. In the following, the invention will be illustrated by means of an example.

### EXAMPLE

1 g of silicon dioxide (Sipernat D22, Degussa) each is placed in a reaction vessel (the inner diameter of the reaction vessel made of glass is 20 mm, the reaction vessel has a rounded bottom). The reaction vessel is furnished with a magnetic stirring tool. The magnetic stirring tool was a round disk with a diameter of 16 mm and a width of 8 mm. The sample is heated under magnetic stirring from room temperature to 80° C. within 30 minutes and is stirred at 2000 revolutions per minute (RPM). At higher revolution number the disk sets upright and fluidizes the powder.

With a pipetting robot, different amounts of ferric nitrate (concentration c=1 mol/l) are added:

| Sample No. | Quantity in μl | Concentration |
|---|---|---|
| 1 | 400 | 1 mol/l |
| 2 | 400 | 1 mol/l |
| 3 | 2500 | 1 mol/l |
| 4 | 2500 | 1 mol/l |

The rate of delivery was 40 μl/sec. The addition was interrupted after 1250 μl during 10 minutes with samples 3 and 4 to allow the evaporation of the liquid. Afterwards the residual 1250 μl were added. The samples were stirred for another 30 minutes.

In a drying chamber with circulating air the samples were dried for 15 hours at 60° C. The dried powder was poured into porcelain bowls and within 60 minutes heated up to 600° C. and maintained for 1 hour at 600° C.

Fine particles with diameters <30 μm were sieved off the calcined samples and rejected.

The surface area of the samples was determined by a 3 point BET measurement using a Micromeritrics ® TriStar nitrogen absorption device. Prior to that, the samples were heated up to 400° C. with an increment of 20° C. per minute and maintained for 3 hours at 400° C.

| Sample | BET in m²/g |
|---|---|
| 1 | 138,3 |
| 2 | 138,5 |
| 3 | 109,4 |
| 4 | 105,4 |
| Sipernat D22 | 173,3 |

The particle size distribution was determined by using an Olympus ® AX70 microscope. Three images per sample were recorded and evaluated. In total, about 150 particles per sample were measured. For the analysis only particles with a surface of greater than 100 μm² were considered.

The particle size distribution was binned as to achieve a more simplified representation. The particle frequency shown as a histogram yields the following results:

| | |
|---|---|
| Class | Particle frequency |

Sample 1

| | |
|---|---|
| 0,00 | 0 |
| 30,00 | 83 |
| 60,00 | 34 |
| 90,00 | 24 |
| 120,00 | 18 |
| 150,00 | 12 |
| 180,00 | 3 |
| 210,00 | 2 |
| 240,00 | 3 |
| 270,00 | 2 |
| 300,00 | 1 |
| 330,00 | 2 |
| and greater | 4 |

Sample 2

| | |
|---|---|
| 0,00 | 0 |
| 30,00 | 148 |
| 60,00 | 24 |
| 90,00 | 8 |
| 120,00 | 12 |
| 150,00 | 6 |
| 180,00 | 4 |
| 210,00 | 2 |
| 240,00 | 4 |
| 270,00 | 1 |
| 300,00 | 1 |
| 330,00 | 2 |
| and greater | 5 |

Sample 3

| | |
|---|---|
| 0,00 | 0 |
| 30,00 | 55 |
| 60,00 | 14 |
| 90,00 | 5 |
| 120,00 | 2 |
| 150,00 | 1 |
| 180,00 | 4 |
| 210,00 | 1 |
| 240,00 | 1 |
| 270,00 | 3 |
| 300,00 | 2 |
| 330,00 | 2 |
| and greater | 5 |

Sample 4

| | |
|---|---|
| 0,00 | 0 |
| 30,00 | 83 |
| 60,00 | 34 |
| 90,00 | 24 |
| 120,00 | 18 |
| 150,00 | 12 |
| 180,00 | 3 |
| 210,00 | 2 |
| 240,00 | 3 |
| 270,00 | 2 |
| 300,00 | 1 |
| 330,00 | 2 |
| and greater | 4 |

SiO₂, Sipernat D22

| | |
|---|---|
| 0,00 | 0 |
| 30,00 | 128 |
| 60,00 | 75 |
| 90,00 | 25 |
| 120,00 | 12 |
| 150,00 | 6 |
| 180,00 | 5 |
| 210,00 | 5 |
| 240,00 | 1 |
| and greater | 1 |

1. Process for the homogeneous mixing of a finely dispersed solid phase with a fluid in a vessel (12), whereby a means (11) for mixing the solid phase is arranged in a moveable manner in the vessel (12) and whereby the diameter of the means (11) is 70-99% of the inner diameter of the vessel (12).

2. Process according to claim 1, characterized in that the primary structure of the solid phase remains essentially unchanged.

3. Process according to claim 1 or 2, characterized in that the solid phase is a powder or a granulate.

4. Process according to claim 3, characterized in that the fluid is introduced into the solid phase in a homogeneous, inhomogeneous or in a combinatorial way.

5. Process according to one of the proceeding claims characterized in that the fluid comprises one or more components.

6. Process according to one of the proceeding claims characterized in that the process is carried out automated in a parallel or sequential manner.

7. Device (10) for the homogeneous mixing of a finely dispersed solid phase with a fluid comprising a vessel (12) and a means (11) for mixing the solid phase (13) which are movably arranged in the vessel (12) and whereby the diameter of the means (11) is 70-99% of the inner diameter of the vessel (12).

8. Device according to claim 7, characterized in that the means (11) is permanently magnetic or permanently magnetizable.

9. Device according to claim 8, characterized in that means are provided for applying a magnetic field.

10. Device according to claim 9, characterized in that the magnetic field can be altered locally in a continuous or periodical way.

11. Device according to one of the previous claims characterized in that the means (11) has paddle-like regions.

12. Array comprising a plurality of devices according to any one of the claims 7-11.

13. Computer program with program code means for carrying out the process according to any one of the claims 1-6.

14. Data carrier with computer program according to claim 13.

15. Computer program according to claim 13 for carrying out the process by using the device according to any one of the claims 7-11.
